(19) United States
(12) Patent Application Publication
(10) Pub. No.: US 2017/0273034 A1
(43) Pub. Date: Sep. 21, 2017

(54) Regulating Antenna Transmit Power based on Proximity of Obstructing Objects

(71) Applicant: Telefonaktiebolaget LM Ericsson (publ), Stockholm (SE)

(72) Inventors: Davide COLOMBI, Stockholm (SE); Björn THORS, Täby (SE); Christer TÖRNEVIK, Solna (SE)

(21) Appl. No.: 15/529,030

(22) PCT Filed: Dec. 8, 2014
(86) PCT No.: PCT/SE2014/051466

§ 371 Date: May 23, 2017

(51) Int. Cl. H04W 52/28; H04B 1/38; H04W 52/36

(52) U.S. Cl. CPC H04W 52/283; H04W 52/367; H04B 1/38; H01Q 1/44

(57) ABSTRACT

The present invention pertains to the field of wireless transmissions and presents exemplary methods for and designs of wireless communication devices. According to one example embodiment, there is provided of a wireless communication device (1), which comprises one or more proximity sensors (5), an antenna arrangement (3) and processing circuitry (7). The processing circuitry (7) is configured to obtain a sensor output (9) from the one or more proximity sensors. The processing circuitry (7) is further configured to control an operation of the antenna arrangement (3) to spatially steer electromagnetic energy transmitted from the antenna arrangement (3) based on the obtained sensor output (9). In exemplary embodiments, the processing circuitry (7) may be configured to control the operation of the antenna arrangement (3) to spatially steer the electromagnetic energy transmitted from the antenna arrangement (3) away from an obstructing object (2) whose proximity has been detected based the sensor output (9).

### TECHNICAL FIELD

The present invention pertains to the field of wireless transmissions; and in particular to the part of this field which is concerned with transmissions from wireless communication devices when obstructing objects may be in proximity of the wireless communication devices.

### BACKGROUND

When a wireless communication device transmits in close proximity to an obstructing object, which may be a user of the device, the efficiency of a transmission may be impaired due to various types of losses induced by the obstructing object.

Moreover, for many wireless communication devices, for example tablets et cetera, intended to be used in close proximity of the user's body, there are government regulations which set limits on electromagnetic field (EMF) exposure.

One way to facilitate compliance with the regulations is found in U.S. Pat. No. 8,417,296 B2, where it is suggested that for some wireless communication devices the EMF exposure limits can be met by a so-called power back-off, that is, a reduction of the transmission power. The power back-off is performed when the device is within a certain distance to the user, which may be established by providing the wireless communication device with so-called proximity sensors.

For most of today's wireless communication devices, EMF exposure limits are, however, usually met at a minimum intended user distance without requiring power back-off. Nevertheless, for frequencies above 6 GHz, the current EMF exposure limits have been shown to be more restrictive in terms of the maximum possible transmission power from a wireless communication device usable in close proximity of the user.

However, limiting the transmission power to lower levels than what is standardized has a negative impact on a communication performance in terms of quality of service, coverage, capacity, et cetera.

Improved technical solutions are therefore needed which can be used, for example, to remove or at least mitigate some of the above-discussed difficulties.

### SUMMARY

The above-indicated problem is solved, for example, with an embodiment of a method in a wireless communication device which comprises one or more proximity sensors and an antenna arrangement. The method comprises an action of obtaining a sensor output from the one or more proximity sensors, where the sensor output from each proximity sensor is indicative of a degree of proximity of an obstructing object. Furthermore, the method comprises an action of controlling an operation of the antenna arrangement to spatially steer electromagnetic energy transmitted from the antenna arrangement based on the obtained sensor output. One advantage is that new options and flexibility are provided in handling of transmissions when obstructing objects may present in the EMF in proximity of the wireless communication device.

In exemplary embodiments, which are applicable when the antenna arrangement comprises a plurality of antennas, the controlling may comprise distributing a total transmission power among the plurality of antennas based on the obtained sensor output.

In exemplary embodiments, which are applicable when the antenna arrangement comprises one or more array antennas, the controlling may comprise an action of controlling a beam forming of the one or more array antennas.

In exemplary embodiments, the method may comprise also power back-off considerations. A power back-off is a reduction of a total transmission power of the antenna arrangement. The method may then comprise an action of determining whether to perform a power back-off. This determination is based on application of a predefined test. The power back-off is then performed, in case it is determined to perform the power-back off. The predefined test may be based on the obtained sensor output.

In exemplary embodiments, the method may comprise controlling the operation of the antenna arrangement to spatially steer the electromagnetic energy transmitted from the antenna arrangement away from the obstructing object. One advantage is then that compliance with government regulations is facilitated without an absolute need to perform a power back-off. Moreover, energy losses may be reduced and the transmitted electromagnetic energy may be used more efficiently, which may impact communication quality positively.

The above-indicated problem is also solved, for example, with an embodiment of a wireless communication device, which comprises one or more proximity sensors, an antenna arrangement and processing circuitry. The processing circuitry is configured to obtain a sensor output from the one or more proximity sensors. Where, as before, the sensor output from each proximity sensor is indicative of a degree of proximity of an obstructing object. The processing circuitry is further configured to control an operation of the antenna arrangement to spatially steer electromagnetic energy transmitted from the antenna arrangement based on the obtained sensor output.

In exemplary embodiments, which are applicable when the antenna arrangement comprises a plurality of antennas, the processing circuitry may be configured to control the antenna arrangement by control of a distribution of total transmission power among the plurality of antennas based on the obtained sensor output.

In exemplary embodiments, which are applicable when the antenna arrangement comprises one or more array antennas, the processing circuitry may be configured to control the antenna arrangement by control of a beam forming of the one or more array antennas.

In exemplary embodiments, the processing circuitry may be configured to determine whether to perform a power back-off based on application of a predefined test. The processing circuitry may be further configured to initiate the power back-off, in case of determining to perform the power-back off. The predefined test may be based on the obtained sensor output.

In exemplary embodiments, the processing circuitry may be configured to control the operation of the antenna arrangement to spatially steer the electromagnetic energy transmitted from the antenna arrangement away from the obstructing object.

The invention will now be described further using embodiments and referring to the drawings. The person skilled in the art will appreciate that further objects, details, effects and advantages may be associated with these exemplary embodiments.

### BRIEF DESCRIPTION OF THE DRAWINGS

FIG. 1 is a schematic diagram illustrating an exemplary situation where embodiment may be used.

FIG. 2 is a block diagram illustrating a wireless communication device according to an embodiment.

FIG. 3 is a flowchart illustrating a method for a wireless communication device according to an embodiment.

FIG. 4 is a block diagram illustrating a wireless communication device according to an embodiment.

FIG. 5 is a block diagram illustrating a wireless communication device according to an embodiment.

FIG. 6 is a flowchart illustrating one option for carrying out power distribution in exemplary embodiments.

FIG. 7 is a flowchart illustrating a way to implement beam forming with an array antenna in exemplary embodiments.

FIG. 8 is flowchart illustrating a way to implement a performance of power back-off in exemplary embodiments.

FIG. 9 is a block diagram illustrating a non-limiting implementation embodiment of processing circuitry.

FIG. 10 is a block diagram illustrating a non-limiting implementation embodiment of processing circuitry.

### DETAILED DESCRIPTION

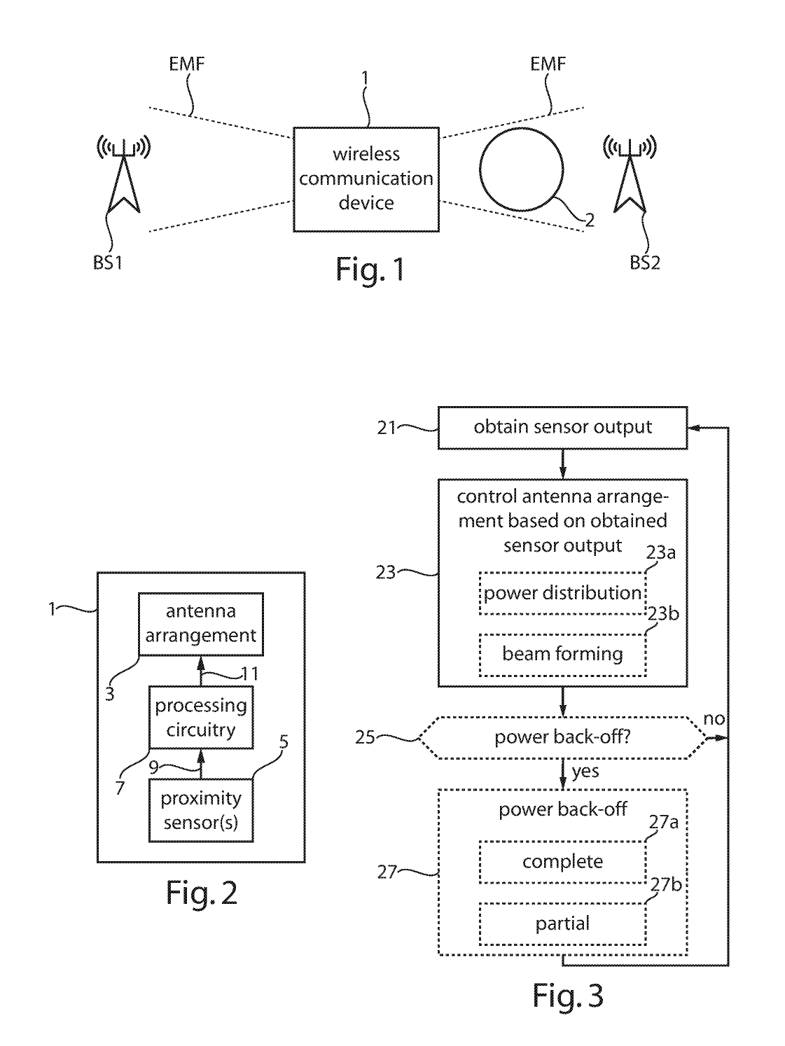

FIG. 1 is a schematic diagram illustrating an exemplary situation where embodiments may be advantageously applied. A wireless communication device 1 communicates using electromagnetic energy (radio signals). In the example of FIG. 1, the wireless communication device 1 is capable of engaging in communications with a cellular communications network, here represented by two base stations BS1 and BS2. The wireless communication device transmits signals to the cellular network using wave propagation of an electromagnetic field (EMF). In FIG. 1, there is, however, an obstructing object 2, which may be, for example, a user of the wireless communication device 1. The obstructing object 2 blocks some the electromagnetic field from reaching the base station BS2 and therefore impairs the communication between the wireless communication device 1 and the base station BS2. Another difficulty, assuming that the obstructing object 2 is the user of the wireless communication device 1, is that it may not be possible to increase a transmission power to provide compensation, since this could cause a violation of government regulations that set limits on the EMF levels that a user may be exposed to. In fact, compliance with such regulations may demand a lowering of the transmission power instead. Embodiments disclosed herein will provide technical designs and methods that will enable wireless devices to cope more effectively with this and other situations.

The term wireless communication device will here be used generally for denoting any device which is capable of wireless communications (communications using radio signals) with other devices or networks. The term wireless communication device consequently comprises, by way of example, any device which may be used by a user for wireless communications. The term may in particular comprise a mobile terminal, a fixed terminal, a user terminal (UT), a wireless terminal, a wireless transmit/receive unit (WTRU), a mobile phone, a cell phone, a table computer, a smart phone, etc. Yet further, the term wireless communication device may comprise MTC (Machine Type Communication) devices, which do not necessarily involve human interaction. MTC devices are sometimes referred to as Machine-to-Machine (M2M) devices.

FIG. 2 is a block diagram illustrating a wireless communication device 1 according to an exemplary embodiment. The wireless communication device 1 comprises an antenna arrangement 3, processing circuitry 7 and one or more proximity sensors 5. The block diagram of FIG. 1 is simplified in order not to obscure the presentation with well-known but, for our purposes, less relevant details of wireless communication device design. For example, the person skilled in the art will know that the wireless communication device 1 may include one or more transceivers which are connected to the antenna arrangement 3 and which provide the signals that are transmitted from the antenna arrangement 3.

The one or more proximity sensors 5 are adapted to detect and/or measure proximity of any obstructing object 2 and provide sensor output 9 which for each sensor is indicative of a degree of proximity of the obstructing object 2. The sensor output 9 may be continuous or discrete (e.g. digital). For a continuous or discrete sensor output 9, the sensor output 9 may be indicative of a distance to the obstructing object 2. In the discrete case, the sensor output 9 may be binary in the sense that it indicates only two possible states: proximity or no proximity detected. Conventional and commercially available techniques, such as capacitive, light or infrared proximity detection, may be used by the one or more proximity sensors 5.

The antenna arrangement 3 is here designed such that an operation of the antenna arrangement 3 can be controlled so as to spatially steer the electromagnetic energy transmitted from the antenna arrangement 3. That is, it is possible to selectively steer the EMF energy associated with the antenna arrangement 3 such that it is transmitted to a greater extent in one or more directions and to a lesser extent in one or more other directions, relative to the orientation of the wireless communication device 1. The processing circuitry 7 is operationally connected to the antenna arrangement 3 and adapted to exercise control of the antenna arrangement 3 using, for example, one or more control signals 11. The control of the antenna arrangement 3 exercised by the processing circuitry 7 is based on the sensor output 9, and the processing circuitry 7 may be adapted to spatially steer the electromagnetic energy away from the obstructing object 2 into one or more other directions. It is therefore possible to comply with EMF exposure regulations without, for example, performing a power back-off, that is, a reduction of a total transmission power of the wireless communication device 1.

FIG. 3 is a flowchart illustrating an exemplary embodiment of a method which, for example, may be carried out by the wireless communication device 1 or other embodiments of wireless communication devices disclosed or indicated herein. In particular embodiments, the actions of the method could, for example, be performed or initiated by the processing circuitry 7. The method of FIG. 3 commences with an action 21 of obtaining the sensor output 9 from the one more proximity sensors 5. At an action 23, the operation of the antenna arrangement 3 is controlled to spatially steer the electromagnetic energy transmitted from the antenna arrangement 3 based on the obtained sensor output 9. This allows the spatial distribution of the electromagnetic energy to be steered based on proximity detection. For example, the electromagnetic energy may be steered away from an obstructing object 2 whose proximity to the wireless device 1 is detected. If several proximity sensors 5 are used, the sensor output 9 may be used together with, for example, positioning techniques to estimate a location of the obstructing object 2 relative to the location and orientation of the wireless device 1; this information may thereafter be used to determine how to spatially steer the electromagnetic energy. The actions 21 and 23 may of course be repeated any number of times.

One non-limiting technique of spatial steering of the electromagnetic energy, which can be used when the antenna arrangement 3 comprises several separate antennas, is herein referred to as power distribution. That is, a total transmission power delivered to the antenna arrangement 3 is distributed to the various antennas based on the sensor output 9. For example, more power can be provided to one or more antennas which transmit predominately in directions away from the obstructing object 2, whereas less power can be provided to one or more antennas that transmit toward the obstructing object 2. Power distribution is indicated as an optional action 23a in FIG. 3.

Another non-limiting technique of spatial steering of the electromagnetic energy is so-called beam forming. Beam forming may be used when the antenna arrangement 3 comprises an array antenna which allows steering of its associated antenna beam(s). An array antenna usually comprises a plurality of antenna elements that are arranged in a regular pattern, usually in the form of a one or two-dimensional array. Shape and/or direction of antenna beam(s) of the array antenna can be steered, for example, by selection complex weights (phase and/or amplitude adjustments) applied to signals provided to the antenna element of the array antenna. Beam forming is indicated as an optional action 23b in FIG. 3.

An advantage with the above-described procedure is that government EMF exposure regulations may be met without having to resort to a power back-off. However, optionally, the above-described procedure in actions 21 and 23 may be combined with power back-off considerations to further enhance operation in specific situations. Hence in an optional action 25, it is determined based on a predefined test, which may involve one or more conditions, whether to perform a power back-off, that is, a reduction of the total transmission power associated with the antenna arrangement 3.

The test in action 25 may be based on the obtained sensor output 9. For example, an evaluation can be made of how reliable an estimation of the location/direction of the obstructing object 2 is; and if the estimation is not sufficiently reliable (e.g. contradictory or inconclusive output from two or more proximity sensors 5), power back-off is made as a precaution to complement the actions 21 and 23. The test in action 25 may also detect whether the obstructing object 2 has a location/direction which is such that it may be difficult to successfully steer the electromagnetic energy away from the obstructing object 2, in which case a power back-off can be made to complement the actions 21 and 23.

In case it is determined to engage in a power back-off in action 25, the power back-off is performed in an action 27. In case the antenna arrangement 3 comprises more than one antenna, the power back-off may be performed on one or more selected antennas, for example, one or more antennas which are deemed as closest to the obstructing object 2 based on the sensor output 9. As indicated by optional actions 27a and 27b, the power back-off may be complete or partial. In a complete power back-off, the power to the selected antenna(s) is reduced to zero, whereas in a partial power back-off the power to the selected antenna(s) is reduced but not to zero.

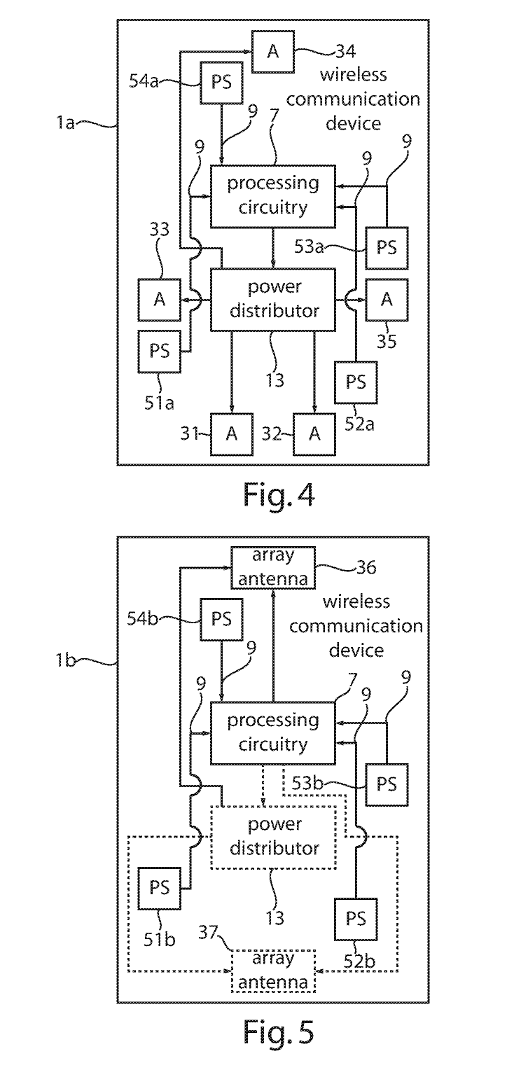

FIG. 4 is a block diagram illustrating a wireless communication device. The wireless communication device in FIG. 4 is referenced as 1a to indicate that it is a non-limiting implementation embodiment, whereas the embodiment of FIGS. 1 and 2 is a more generic embodiment. The embodiment of FIG. 4 is intended to illustrate embodiments where the antenna arrangement comprises a plurality of antennas. By way of example, the wireless communication device 1a in FIG. 4 is equipped with five antennas 31-35, transmitting towards the front (out of paper), back (into paper), left, right and top of the wireless communication device 1a, respectively. In the wireless communication device 1a, the one or more proximity sensors 5 specifically, by way of example, comprise four proximity sensors 51a-54a, which detect proximity of any obstructing object(s) 2. The proximity sensors 51a-54a may be placed and designed so that a detection of proximity of the obstructing object(s) 2 is discerned to a required extent. The proximity sensors 51a-54a may, for example, provide a binary output (proximity of obstructing object detected/not detected) or an output indicative of how far away the obstructing object 2 is located from, for example, the antennas 31-35. The wireless communication device 1a comprises processing circuitry 7 which may be configured to obtain and process the sensor output 9 to determine how to distribute a given total transmission power among the antennas 31-35 in order spatially steer the electromagnetic energy transmitted by the antennas. In the example of FIG. 4, the wireless communication device 1a comprises a power distributor 13 which is configured to execute the power distribution determined by the processing circuitry 7. The power distributor 13 is configured to distribute the total transmission power of a signal from a radio transmitter (not shown) among the antennas 31-35 in accordance with control instructions from the processing The power distributor 13 is configured to distribute the total transmission power of a signal from a radio transmitter (not shown) among the antennas 31-35 in accordance with control instructions from the processing circuitry 7. The processing circuitry 7 may also implement a power back-off option as discussed earlier.

Table 1 below illustrates some purely exemplary cases for how the sensor output 9 can be used by the processing circuitry 7 to determine the distribution of the total transmission power (Pₜ) among the antennas 31-35. The table 1 (or an extended version) may be stored on a readable memory (not shown in FIG. 4) and be consulted by the processing circuitry 7 when needed. The table 1 assumes that the sensor output 9 has been used to first determine for each antenna whether an obstructing object 2 is in proximity of the antenna or not.

TABLE 1

| | | | Transmitted power |
|---|---|---|---|
| Case No. | Antenna No. | Proximity detected | per element |
| 1 | 31 | No | Pₜ/5 |
| | 32 | No | Pₜ/5 |
| | 33 | No | Pₜ/5 |
| | 34 | No | Pₜ/5 |
| | 35 | No | Pₜ/5 |
| 2 | 31 | No | Pₜ/4 |
| | 32 | Yes | 0 |
| | 33 | No | Pₜ/4 |
| | 34 | No | Pₜ/4 |
| | 35 | No | Pₜ/4 |
| 3 | 31 | No | 2Pₜ/5 |
| | 32 | Yes | 0 |
| | 33 | No | Pₜ/5 |
| | 34 | No | Pₜ/5 |
| | 35 | No | Pₜ/5 |
| 4 | 31 | No | Pₜ/3 |
| | 32 | Yes | 0 |
| | 33 | No | Pₜ/3 |
| | 34 | Yes | 0 |
| | 35 | No | Pₜ/3 |

Case 1 is a case where the total transmitted power Pₜ is uniformly distributed (equal share) among the 5 antennas when no proximity has been detected.

In Case 2, the processing circuitry 7 has deduced proximity to the obstructing object 2 for antenna 32 and instructs the Power Distributor to divide the available power among the remaining 4 antennas.

An example of a non-uniform power distribution is illustrated in Case 3 of table 1 where the transmission power of antenna 32 is directed to antenna 31 after proximity to the obstructing object 2 has been detected for antenna 32. Situations may also occur where proximity to the obstructing object 2 is detected for more than one antenna. An example of this is illustrated in Case 4 of table 1.

Any other type of power distribution algorithm may also be implemented, both before and after proximity has been detected, e.g. in order to maximize coverage or capacity performance.

FIG. 5 is a block diagram illustrating a wireless communication device. The wireless communication device in FIG. 5 is referenced as 1b to indicate that it is a non-in FIG. 5 is equipped with array antennas 36 and 37, where, for example, the array antenna 37 may be optional. In the wireless communication device 1a, the one or more proximity sensors 5 specifically, by way of example, comprise four proximity sensors 51b-54b, which detect proximity of any obstructing object(s) 2. The proximity sensors 51b-54b may be placed and designed so that a detection of proximity of the obstructing object(s) 2 is discerned to a required extent. The proximity sensors 51b-54b may, for example, provide a binary output (proximity of obstructing object detected/not detected) or an output indicative of how far away the obstructing object 2 is located from, for example, the array antennas 36 and 37. The wireless communication device 1b comprises processing circuitry 7 which may be configured to obtain and process the sensor output 9 and to determine how to set the beam forming of the array antennas 36 and 37 in order spatially steer the electromagnetic energy from the array antennas 36 and 37. The processing circuitry 7 may for example be configured to control the beam forming by appropriate selection of the complex weights associated with the antenna elements of the array antennas 36 and 37. Optionally, the wireless communication device 1b may also comprise a power distributor 13, and the processing circuitry 7 may be configured to use the power distributor 13 to implement also power distribution among the array antennas 36 and 37, as an additional measure for spatial steering of the electromagnetic energy. The processing circuitry 7 may also implement a power back-off option.

The embodiments of FIGS. 4 and 5 may be combined. That is, embodiments are contemplated which include one or more individual antennas as in FIG. 4 and one or more array antennas as in FIG. 5. In such embodiments, both power distribution and beam forming may be used.

The processing circuitry 7 may be implemented with conventional electronic circuit technologies, which exist in profusion. The processing circuitry 7 may, for example, be implemented using circuitry with individual hardware components, application specific integrated circuitry, programmable circuitry or any combination thereof. The processing circuitry 7 may also fully or partially be implemented using one or more digital processors and computer readable memory with program code which may be executed by the one or more digital processors to perform one or more functions performed by the processing circuitry 7.

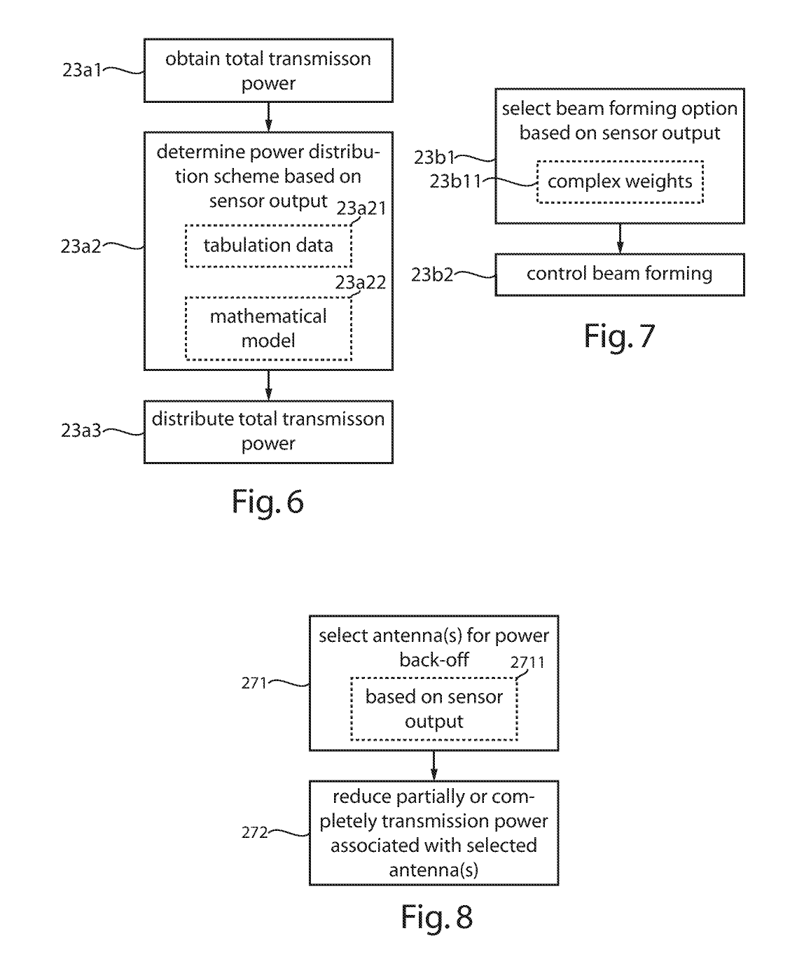

FIG. 6 is a flowchart illustrating one non-limiting way of carrying out a power distribution option. This option is, as mentioned, applicable when the antenna arrangement 3 comprises a plurality of antennas. At an action 23a1, a total transmission power is obtained. This may, for example, entail reading the total transmission from an entry in a memory or an actual determination of the total transmission power to be used. At an action 23a2, a power distribution scheme is determined based on the sensor output 9. The power distribution scheme is a specification of how the total transmission power should be distributed among the plurality of antennas.

One non-limiting technique for determining the power distribution scheme is to use tabulation data that may be stored on a memory. The tabulation data, which by way of example may be the same or similar as table 1, links sensor output 9 to power distribution schemes in a predetermined way. The use of tabulation data is indicated as an optional action 23a21 in FIG. 6.

Another non-limiting technique for determining the power distribution scheme is to use a mathematical model that links the sensor output 9 to power distribution schemes. The mathematical model may be selected, for example, with an aim to maximize coverage or capacity performance. The mathematical model may, in addition to using the sensor output 9, be dependent on external information from, for example, a network with which the wireless communication device communicates. For example, the external information may indicate a selection of a mathematical model from a plurality of predefined mathematical models. The use of a mathematical model is indicated as an optional action 23a22 in FIG. 6.

At an action 23a3, the total transmission power is distributed among the antennas in accordance with the determined power distribution scheme.

The methodology of FIG. 6 may of course, when applicable, be implemented with any embodiment disclosed or indicated herein.

FIG. 7 is a flowchart illustrating a non-limiting way to implement beam forming with an array antenna. At an action 23b1, a beam forming option is selected based on the sensor output 9. That is, an option for how to shape and/or direct beam(s) of the array antenna(s) based on the information regarding any obstructing object 2 provided by the sensor output 9. As indicted as an optional action 23b11, this may comprise selecting complex weights for the antenna elements of the array antenna(s). At an action 23b2, the beam forming is controlled to correspond to the selected beam forming option, for example, by implementing the selected complex weights in the array antenna(s).

The methodology of FIG. 7 may of course, when applicable, be implemented with any embodiment disclosed or indicated herein.

FIG. 8 is a flowchart illustrating one non-limiting way to implement a performance of power back-off. At an action 271, one or more antennas are selected to be involved in the power back-off. As indicated by an optional action 2711, the selection of the antennas may be made based on the sensor output 9. For example, any antenna which is closer than a threshold distance to the obstructing object 2 may be selected, or be a candidate for selection together with further considerations. At an action 272, the transmission power associated with the selected one or more antennas is reduced partially or completely to reduce a total transmission power.

The methodology of FIG. 8 may of course, when applicable, be implemented with any embodiment disclosed or indicated herein.

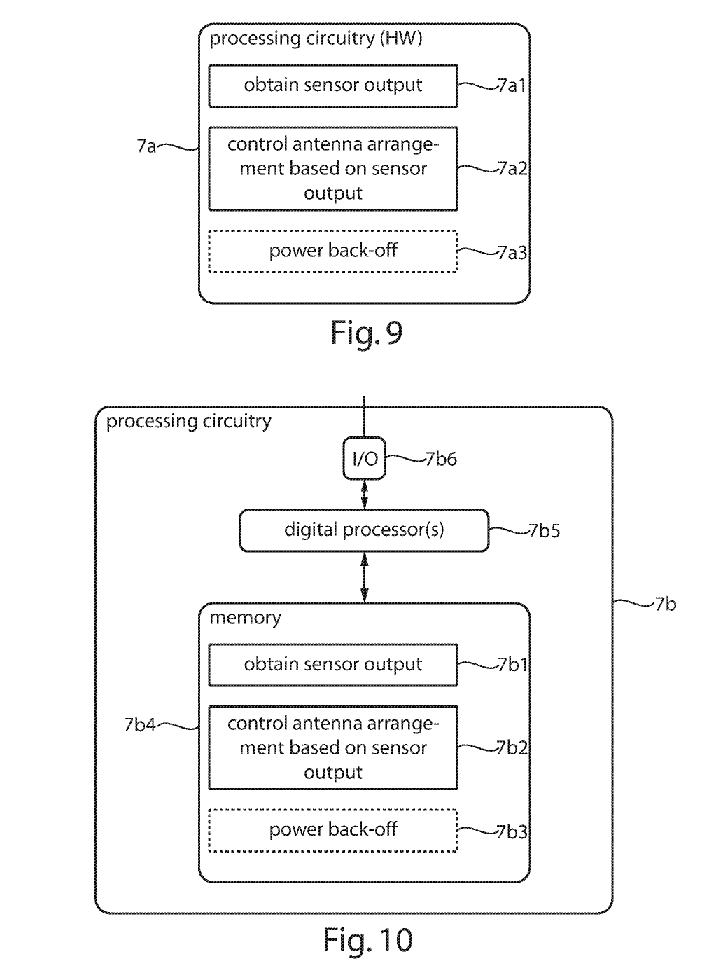

FIG. 9 is a block diagram illustrating a non-limiting implementation embodiment of processing circuitry 7a which optionally may be used as the processing circuitry 7 used in embodiments disclosed and indicated herein. The processing circuitry 7a is a hardware-only alternative with circuits specifically designed for various purposes. Consequently, the processing circuitry 7a comprises circuitry 7a1 configured to obtain the sensor output 9 from the proximity sensors 5. The processing circuitry 7a further comprises circuitry 7a2 configured for controlling an operation of the antenna arrangement 3 to spatially steer electromagnetic energy transmitted from the antenna arrangement 3 based on the obtained sensor output 9, for example, in any one of the ways disclosed or indicated above. Optionally, the processing circuitry 7a may comprise also circuitry 7a3 configured to handle power back-off procedures, for example, in any one of the ways disclosed or indicated earlier.

In exemplary embodiments, the circuitry blocks 7a1-7a3 may be implemented as separate, but co-operating, units or modules, for example, as physically separate operationally connected circuit boards.

FIG. 10 is a block diagram illustrating another non-limiting implementation embodiment of processing circuitry 7b which optionally may be used as the processing circuitry 7 used in embodiments disclosed or indicated herein. The processing circuitry 7b is intended to illustrate an alternative based on digital processors and software. Consequently, the processing circuitry 7b comprises one or more digital processors 7b5, here, by way of example, connected to an input/output (I/O) interface 7b6. In exemplary embodiments, the digital processor(s) 7b5 may, for example, comprise microprocessor(s), digital signal processor(s), micro controller(s), or combinations thereof. The digital processor(s) 7b5 are configured for carrying out functions using computer executable program code (code for short) instructions stored on a computer readable memory (memory for short) 7b4. Consequently, the memory 7b4 comprises code 7b1 with instructions to obtain the sensor output 9 from the proximity sensors 5. The memory 7b4 further comprises code 7b2 with instructions for controlling an operation of the antenna arrangement 3 to spatially steer electromagnetic energy transmitted from the antenna arrangement 3 based on the obtained sensor output 9, for example, in any one of the ways disclosed or indicated above. Optionally, the memory 7b4 may comprise also code 7b3 with instructions to handle power back-off procedures, for example, in any one of the ways disclosed or indicated earlier.

Above, the invention has been described with various embodiments. These embodiments are only to be viewed as non-limiting examples, and the scope of protections is instead defined by the appending claims. In particular, a technical feature should not be viewed as essential only because it has been mentioned in connection with an exemplary embodiment.

1-21. (canceled)

22. A method in a wireless communication device comprising one or more proximity sensors and an antenna arrangement, the method comprising:
obtaining a sensor output from the one or more proximity sensors, the sensor output from each proximity sensor being indicative of a degree of proximity of an obstructing object; and
controlling an operation of the antenna arrangement to spatially steer electromagnetic energy transmitted from the antenna arrangement based on the obtained sensor output.

23. The method of claim 22, wherein:
the antenna arrangement comprises a plurality of antennas; and wherein
the controlling comprises distributing a total transmission power among the plurality of antennas based on the obtained sensor output.

24. The method of claim 23, wherein the distributing comprises:
determining an antenna power distribution scheme based on the obtained sensor output and stored tabulation data which maps sensor output to antenna power distribution schemes; and
distributing the total transmission power among the plurality of antennas in accordance with the determined antenna power distribution scheme.

25. The method of claim 23, wherein the distributing comprises:
determining an antenna power distribution scheme based on the obtained sensor output and a mathematical model that links sensor output to antenna power distribution schemes; and
distributing the total transmission power among the plurality of antennas in accordance with the determined antenna power distribution scheme.

26. The method of claim 22, wherein the method further comprises:
determining whether to perform a power back-off based on application of a predefined test, the power back-off being a reduction of a total transmission power of the antenna arrangement; and
performing the power back-off, in case of determining to perform the power-back off.

27. The method of claim 26, wherein the predefined test is based on the obtained sensor output.

28. The method of claim 26, wherein:
the antenna arrangement comprises a plurality of antennas;
the controlling comprises distributing a total transmission power among the plurality of antennas based on the obtained sensor output; and
performing the power-back off comprises:
selecting, from the plurality of antennas, one or more antennas which are to be involved in the power back-off; and
reducing partially or completely a transmission power associated with the selected one or more antennas such that a total transmission power of the antenna arrangement is reduced.

29. The method of claim 28, wherein the selecting of the one or more antennas is based on the sensor output.

30. The method of claim 22, wherein:
the antenna arrangement comprises one or more array antennas; and
the controlling comprises controlling a beam forming of the one or more array antennas.

31. The method of claim 22, wherein the controlling comprises controlling the operation of the antenna arrangement to spatially steer the electromagnetic energy transmitted from the antenna arrangement away from the obstructing object.

32. A wireless communication device comprising one or more proximity sensors, an antenna arrangement and processing circuitry, the processing circuitry being configured to:
obtain a sensor output from the one or more proximity sensors, the sensor output from each proximity sensor being indicative of a degree of proximity of an obstructing object; and to
control an operation of the antenna arrangement to spatially steer electromagnetic energy transmitted from the antenna arrangement based on the obtained sensor output.

33. The wireless communication device of claim 32, wherein:
the antenna arrangement comprises a plurality of antennas; and wherein
the processing circuitry is configured to control the antenna arrangement by control of a distribution of total transmission power among the plurality of antennas based on the obtained sensor output.

34. The wireless communication device of claim 33, wherein the processing circuitry is configured to:
determine an antenna power distribution scheme based on the obtained sensor output and stored tabulation data which links sensor output to antenna power distribution schemes; and to
control the distribution of the total transmission power among the plurality of antennas in accordance with the determined antenna power distribution scheme.

35. The wireless communication device of claim 33, wherein the processing circuitry is configured to:
determine an antenna power distribution scheme based on the obtained sensor output and a mathematical model that links sensor output to antenna power distribution schemes; and to
control the distribution of the total transmission power among the plurality of antennas in accordance with the determined antenna power distribution scheme.

36. The wireless communication device of claim 32, wherein the processing circuitry is configured to:
determine whether to perform a power back-off based on application of a predefined test, the power back-off being a reduction of a total transmission power of the antenna arrangement; and to
initiate the power back-off, in case of determining to perform the power-back off.

37. The wireless communication device of claim 36, wherein the predefined test is based on the obtained sensor output.

38. The wireless communication device of claim 36, wherein:
the antenna arrangement comprises a plurality of antennas;
the processing circuitry is configured to control the antenna arrangement by control of a distribution of total transmission power among the plurality of antennas based on the obtained sensor output; and
the processing circuitry is further configured to:
select, from the plurality of antennas, one or more antennas which are to be involved in the power back-off; and to
reduce partially or completely a transmission power associated with the selected one or more antennas such that a total transmission power of the antenna arrangement is reduced.

39. The wireless communication device of claim 38, wherein the processing circuitry is configured to select the one or more antennas based on the sensor output.

40. The wireless communication device of claim 32, wherein:
the antenna arrangement comprises one or more array antennas; and wherein
the processing circuitry is configured to control the antenna arrangement by control of a beam forming of the one or more array antennas.

41. The wireless communication device of claim 32, wherein the processing circuitry is configured to control the operation of the antenna arrangement to spatially steer the electromagnetic energy transmitted from the antenna arrangement away from the obstructing object.

42. The wireless device of claim 32, wherein the processing circuitry comprises one or more digital processors and computer readable memory with program code which can be executed by the one or more digital processors for performing one or more functions of the processing circuitry.
